(19) United States
(12) Patent Application Publication
(10) Pub. No.: US 2010/0268508 A1
(43) Pub. Date: Oct. 21, 2010

(54) SYSTEM AND METHOD FOR MEASURING TILT USING LOWEST DEGREES OF FREEDOM OF ACCELEROMETER

(75) Inventors: Edwin Gerardus Johannus Maria Bongers, Thorn (NL); Victor Martinus Gerardus Acht, Waalre (NL); Nicolaas Lambert, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/809,804

(22) PCT Filed: Dec. 29, 2008
(86) PCT No.: PCT/IB08/55568

§ 371 Date: Jun. 21, 2010

Related U.S. Application Data
(60) Provisional application No. 61/017,193, filed on Dec. 28, 2007.

(51) Int. Cl. G01C 9/00; G01P 15/00

(52) U.S. Cl. 702/141; 702/154

(57) ABSTRACT

Systems and methods are provided for calculating the tilt of an object from a minimum set of measurements. In the described embodiments, one or more accelerometers are used to sense tilt in fewer degrees of freedom than would otherwise be required in a conventional measurement apparatus. In one embodiment, a single axis accelerometer measures 2D tilt by taking into account a constant value of the earth's gravitational field in a direction generally perpendicular to the earth.

The invention relates generally to an apparatus and method for measuring tilt using an accelerometer sensing a minimal number of degrees of freedom.

Accelerometers and gyroscopes belong to a class of devices known as motion detection inertial sensors. In general, a motion detection inertial sensor provides information about the movement/orientation of a device. An accelerometer provides information about the movement/orientation of a device by measuring its own acceleration as opposed to measuring the acceleration of a remote device. Accelerometers are often used along with gyroscopes in inertial navigation and guidance systems. A common use of accelerometers is in airbag deployment systems for automobiles. Another common use of accelerometers is for detecting the tilt of a device. Depending on the information of interest a 2D or 3D accelerometer may be used for detecting tilt.

For the most part, the cost and size of an accelerometer depends on the total number of axes that the accelerometer can measure. For example, an accelerometer that is sensitive to accelerations in the Z-axis (perpendicular to the plane of the silicon chip), will cost much more than an accelerometer that measures only X and Y accelerations (in the same plane as the silicon die). Moreover, the noise level of the Z-axis is typically much higher than that of the X and Y axis, the reduction of which can increase costs. It is therefore apparent that in order to reduce costs, it is desired to eliminate as many sensor axes as possible in the construction of an accelerometer.

A need therefore exists for an accelerometer and associated method for measuring 1D, 2D and 3D tilt sensing only a minimal number of degrees of freedom to minimize costs.

Therefore, the present invention has been made in view of the above problems. Accordingly, the present invention provides a system and method for calculating the tilt from a minimum set of measurements. In the described embodiments, one or more accelerometers are used to sense tilt in fewer degrees of freedom than would otherwise be required in a conventional measurement apparatus. In this regard, the cost and size of the accelerometers is reduced. In one embodiment, a single axis accelerometer measures 2D tilt by taking into account a constant value of the earth's gravitational field in a direction generally perpendicular to the earth.

Components of the apparatus may be individually capable of inertially sensing or determining the direction of gravity. One of the accelerometers may, for example, advantageously, be a MEMS accelerometer.

These and other objects, features and advantages of the invention will be apparent from a consideration of the following detailed description of the invention considered in conjunction with the drawing Figures, in which:

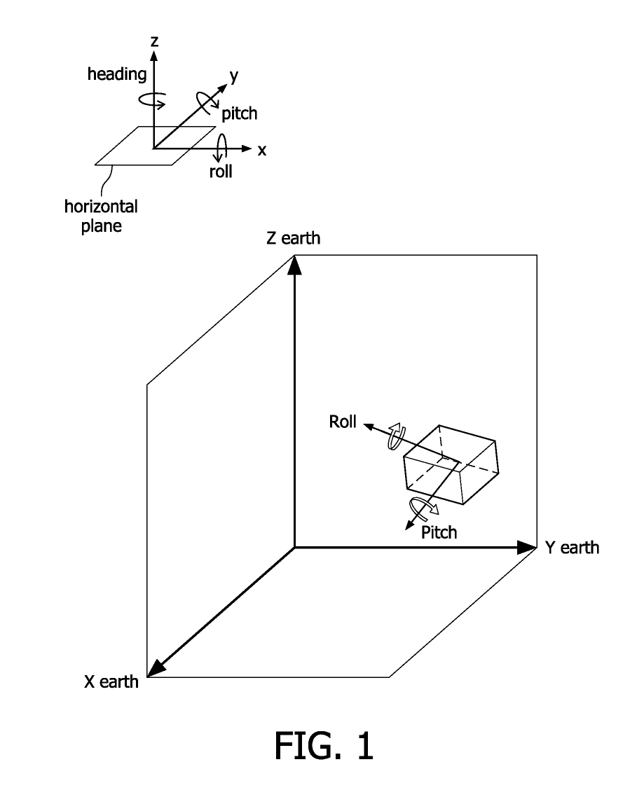

FIG. 1 is an illustration of a method for measuring a device 10 with respect to a 3-D coordinate system of the earth, according to the prior art;

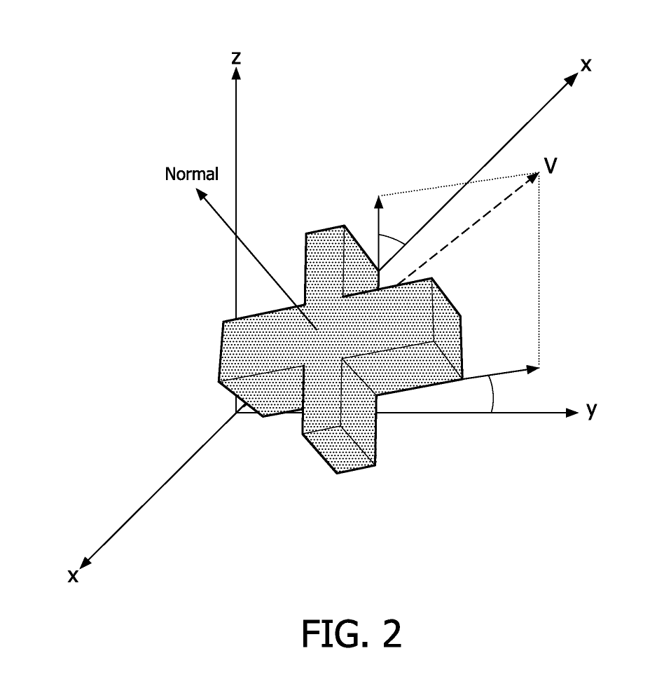

FIG. 2 is an illustration of a device oriented at an arbitrary angle α with respect to the z-axis, for illustrating a method for measuring a device 10 with respect to a 3-D coordinate system of the earth, according to one embodiment;

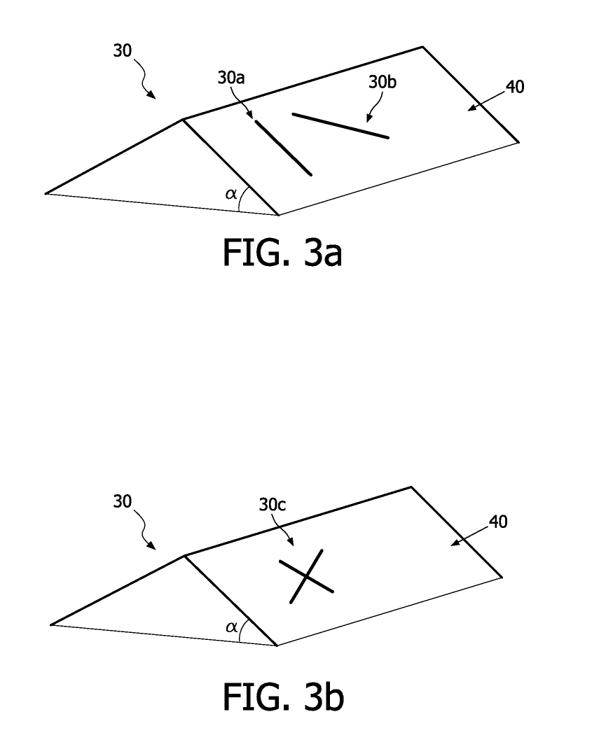

FIGS. 3a & 3b are illustrations of, respectively, use of a prior art leveling instrument and a leveling instrument of the present invention.

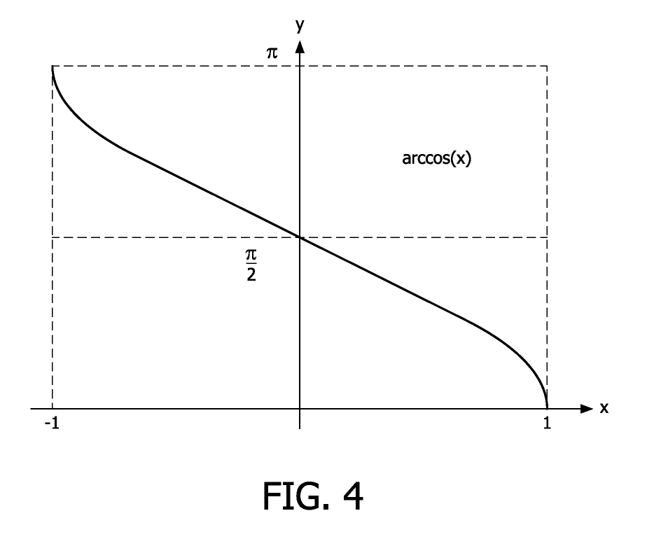

FIG. 4 is a graph of the arccos function, illustrating a relationship between accuracy and vertical alignment of a sensor axis.

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

It should be appreciated that the present invention can be implemented in numerous ways, including as a process, an apparatus, a system, a device and a method.

FIG. 1 is an illustration of a method for measuring a device 10 with respect to a 3-D coordinate system of the earth, according to the prior art. Each axis has associated with it a particular “type” of tilt that the device 10 may experience. For example, in the “y-direction” the tilt “type” is referred to as “pitch”. In the x and z directions, the tilt “type” is referred to as “roll” and “heading”, respectively. Measurements are made in accordance with a right-handed coordinate system, as illustrated in the legend.

For the purposes of illustration, it is assumed that there is a tilt in both “pitch” and “roll” in the device 10 of FIG. 1. This is measurable with a 3D accelerometer. Acceleration is measured by the 3D accelerometer in the y-axis, x-axis and z-axis, respectively. A tilt angle pitch and tilt angle roll can then be easily computed from the acceleration measurements, as follows:

$$\begin{matrix}TiltAnglePitch = arcsin \frac{{}_{ }^{s}{A}{}_{my}^{ }}{{}_{ }^{s}{A}{}_{mz}^{ }} & Eq . [ 1 ] \\ TiltAngleRoll = arcsin \frac{{}_{ }^{s}{A}{}_{mx}^{ }}{{}_{ }^{s}{A}{}_{mz}^{ }} & Eq . [ 2 ]\end{matrix}$$

Where:

^{s}A_{my}: Measured acceleration in the y-axis.
^{s}Aₘₓ: Measured acceleration in the x-axis.
^{s}A_{mz}: Measured acceleration in the z-axis.
TiltAnglePitch: Angle with respect to the y axis
TiltAngleRoll: Angle with respect to the x axis

As described, the measurement of tilt with respect to the three co-ordinate axes requires a conventional 3D accelerometer. As will become apparent in the description to follow, the invention provides methods and apparatus to make measurements in three co-ordinate axes using fewer degrees of freedom. In this manner, both a cost, power and space savings of measurement apparatus may be realized.

### First Embodiment

In accordance with a first embodiment, to sense tilt using fewer degrees of freedom than would otherwise be required in a conventional measurement apparatus, as described above, the inventors have recognized that the measured acceleration in the z-axis of a world coordinate frame, ⁰A_{ez}, is a constant and is equal to 9.8 m/s². In other words, it is recognized by the inventors that it is well established that the gravitation field is always essentially perpendicular to the earth, i.e., the vertical component of tilt in both the pitch and roll directions. This information can be used advantageously in equations 1 and 2 above, which allows for a reduction in the number of sensing degrees required to make tilt measurements. In the present embodiment, a conventional 3D accelerometer may be replaced by a two single-axis accelerometers for measuring tilt in the x and y axes, respectively. Thus, a reduction in sensing degree from a single 3D accelerometer to two single-axis accelerometers is realized. Accordingly, a method for measuring tilt in the x and y axes is achieved by measuring tilt in the x-axis using a first accelerometer. Then, measuring tilt in the y axis using a second accelerometer and using the two measurements in equations 3 and 4, as follows:

$$\begin{matrix}TiltAnglePitch = arcsin \frac{{}_{ }^{s}{A}{}_{my}^{ }}{{}_{ }^{0}{A}{}_{e}^{ }} & Eq . [ 3 ] \\ TiltAngleRoll = arcsin \frac{{}_{ }^{s}{A}{}_{mx}^{ }}{{}_{ }^{0}{A}{}_{e}^{ }} & Eq . [ 4 ]\end{matrix}$$

### Where:

^{s}A_{my}: Measured acceleration in the y-axis.
^{s}Aₘₓ: Measured acceleration in the x-axis.
⁰Aₑ: Constant of 9.81 m/s²
TiltAnglePitch: Angle with respect to the y axis
TiltAngleRoll: Angle with respect to the x axis

### Second Embodiment

The previous embodiment described the separate computations of roll and pitch of a device 10 in the x and y directions respectively. These two results are quantified in equations 3 and 4 above. In the present embodiment, it is contemplated to compute a single tilt angle α that represents both the roll and the pitch of the device 10.

Referring now to FIG. 2, there is shown a device 10 oriented at an arbitrary angle α with respect to the z-axis, where α represents both the roll and pitch of the device 10. To compute the angle α, a normal vector is first computed as shown in equation (5) taking into account the fact that the acceleration measurement in the z direction ⁰A_{ez}, is a constant and is equal to 9.8 m/s²:

V=\sqrt{^{s}Aₘₓ²+^{s}A_{my}²+9.81²} Eq. [5]

Equations (6)-(8) describe computational steps for computing the angle α from the normal vector V,

$$\frac{V}{\vert V \vert} \cdot ( \begin{matrix}0 \\ 0 \\ 1\end{matrix} ) = cos α \qquad Eq . [ 6 ]$$

This can be re-written as:

$$arccos \sqrt{1 - {( \frac{{}_{ }^{s}{A}{}_{mx}^{ }}{{}_{ }^{0}{A}{}_{e}^{ }} )}^{2} - {( \frac{{}_{ }^{s}{A}{}_{my}^{ }}{{}_{ }^{0}{A}{}_{e}^{ }} )}^{2}} = α \qquad Eq . [ 7 ]$$

Which is equal to:

$$arcsin \sqrt{{( \frac{{}_{ }^{s}{A}{}_{mx}^{ }}{{}_{ }^{0}{A}{}_{e}^{ }} )}^{2} + {( \frac{{}_{ }^{s}{A}{}_{my}^{ }}{{}_{ }^{0}{A}{}_{e}^{ }} )}^{2}} = α \qquad Eq . [ 8 ]$$

Where
^{s}A_{my}: Measured acceleration in the y-axis.
^{s}Aₘₓ: Measured acceleration in the x-axis
⁰Aₑ: Constant of 9.81 m/s²
α: The angle between the normal of the plane and the gravitation field (real z of the earth).

The advantage of producing a single tilt angle α is that it represents both the roll and the pitch of the device 10. This is shown by way of example with reference to FIGS. 3a and 3b, described as follows.

Referring now to FIG. 3a, there is shown a conventional leveling instrument 30 in two different orientations 30a and 30b for measuring the pitch (i.e., a tilt angle α) of a roof 40. To measure the tilt angle α with the instrument 30, the instrument 30 must be placed on the roof 40 to make the steepest slope with respect to the horizontal. It should be understood that making the steepest slope is a stringent requirement that is not easily achieved in practice. For example, an ideal orientation for making the steepest slope with respect to the horizontal is shown in orientation 30a. A less than ideal orientation is shown as orientation 30b. This drawback is overcome by the invention in computing the tilt angle α in a manner that is independent of the orientation of the leveling device 30. Specifically, equations 5-8 provide a way to calculate a single tilt angle α that represents both the roll and the pitch of the device 30, independent of device orientation. Beneficially, by computing the tilt angle α in the manner described above, sensor placement is not critical. That is, an operator is no longer required to precisely point the leveling instrument 30 in such a way as to make the steepest slope with respect to the horizontal. This is because by computing the tilt angle α in the manner described above with respect to equations 5-8, the computation is independent of the rotation of the leveling instrument 30 in the plane that is being measured.

It will now become apparent that this advantage translates to other applications including, for example, wireless sensors attached to the limbs of a patient. The wireless sensors may be shifted, tilted, rotated and so on without impacting the measurement of the tilt angle α. Hence, sensor placement inaccuracy can be largely neglected.

### Third Embodiment

Recall from the previous embodiment that the normal vector V was calculated to derive the angle α, which is the angle that is formed by the device 10 with respect to the z-axis. In the present embodiment, instead of calculating the normal vector V, it is calculated in the manner to be described.

Referring again to FIG. 2, which illustrates a device 10 oriented at an arbitrary angle α with respect to the z-axis, where α represents both the roll and pitch of the device 10. In the present embodiment, to derive α, instead of first calculating V, the normal vector, requiring two acceleration measurement in the x and y directions, respectively, the normal vector, V, is measured using a single accelerometer measurement in the z-axis direction, A_{mz}. Using the single z-axis measurement, the angle α, which represents the angle between the normal of the plane and the gravitational field z, representing the roll and pitch of the device 10, can then be computed as:

$$α = arccos \frac{{}_{ }^{s}{A}{}_{mz}^{ }}{{}_{ }^{0}{A}{}_{e}^{ }} \qquad Eq . [ 9 ]$$

One disadvantage of this approach is that the accuracy of the angle α is influenced by the real angle of the device 10 with respect to the gravitational field. This is further explained with respect to the graph of FIG. 4 which is a graph of arcos. If the real angle of the device 10 with respect to the gravitational field is around Π/2, then the sensitivity is highest. This results in a variation of accuracy in equation (9). In the Π/2 range of the graph (e.g., the central portion), the angle increasingly depends on the noise of the z-axis accelerometer.

Finally, the above-discussion is intended to be merely illustrative of the present invention and should not be construed as limiting the appended claims to any particular embodiment or group of embodiments. Each of the systems utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference numerals in the claims are for illustration purposes only and do not limit their protective scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

What is claimed is:

1. A method for measuring tilt of an object sensing a minimum number of degrees of freedom, the method comprising:
a) measuring a tilt of a first movement sensor along a first axis via a measured acceleration in the direction of said first axis;
b) measuring a tilt of a second movement sensor along a second axis via a measured acceleration in the direction of said second axis;
c) calculating a tilt angle of said object with respect to said first axis from said measured tilt along said first axis and a known acceleration along a third axis;
d) calculating another tilt angle of said object with respect to said second axis from said measured tilt along said second axis and a known acceleration along said third axis.

2. A method according to claim 1, further comprising: displaying resultant tilt angles along said first, second and third axes, from acceleration measurements made along said first and second axes at steps (a) and (b), respectively.

3. A method according to claim 1, wherein said first and second sensors are accelerometers.

4. A method according to claim 1, wherein said known acceleration along said third axis is 9.8 m/s².

5. A method according to claim 1, wherein said step (c) of calculating a tilt angle of said object with respect to said first axis from said measured tilt along said first axis and a known acceleration along a third axis, is computed as:
$$First\_Axis \_Tilt \_Angle = arcsin \frac{{}_{ }^{s}{A}{}_{my}^{ }}{{}_{ }^{0}{A}{}_{e}^{ }}$$
A_{my} is a measured acceleration along said first axis,
Aₑ is a constant of 9.81 m/s².

6. A method according to claim 1, wherein said step (d) of calculating another tilt angle of said object with respect to said second axis from said measured tilt along said second axis and a known acceleration along said third axis, is computed as:
$$Second\_Axis \_Tilt \_Angle = arcsin \frac{{}_{ }^{s}{A}{}_{mx}^{ }}{{}_{ }^{0}{A}{}_{e}^{ }}$$
Aₘ is a measured acceleration along said second axis,
Aₑ is a constant of 9.81 m/s².

7. A method according to claim 1, wherein said first movement sensor is a single axis sensor.

8. A method according to claim 1, wherein said second movement sensor is a single axis sensor.

9. A tilt sensor system for measuring the tilt of an object sensing a minimum number of degrees of freedom, the system comprising:
means for measuring the tilt of a first movement sensor along a first axis via a measured acceleration in the direction of said first axis;
means for measuring the tilt of a second movement sensor along a second axis via a measured acceleration in the direction of said second axis;
means for calculating a tilt angle of said object with respect to said first axis from said measured tilt along said first axis and a known acceleration along a third axis;
means for calculating another tilt angle of said object with respect to said second axis from said measured tilt along said second axis and a known acceleration along said third axis.

10. A tilt sensor system according to claim 9, further comprising: display of resultant tilt angles along said first, second and third axes from acceleration measurements made along said first and second axes by the means for measuring the tilt of the first movement sensor and the means for measuring the tilt of the second movement sensor, respectively.

11. A tilt sensor system according to claim 9, wherein said first and second sensors are accelerometers.

12. A tilt sensor system according to claim 9, wherein said known acceleration along said third axis is 9.8 m/s².

13. A tilt sensor system according to claim 9, wherein the means for calculating a tilt angle of said object with respect to said first axis from said measured tilt along said first axis and a known acceleration along a third axis, comprises calculating the tilt angle as:
$$First\_Axis \_Tilt \_Angle = arcsin \frac{{}_{ }^{s}{A}{}_{my}^{ }}{{}_{ }^{0}{A}{}_{e}^{ }}$$
A_{my} is a measured acceleration along said first axis,
Aₑ is a constant of 9.81 m/s².

14. A tilt sensor system according to claim 9, wherein said means for calculating another tilt angle of said object with respect to said second axis from said measured tilt along said second axis and a known acceleration along said third axis comprises calculating the tilt angle as:
$$Second\_Axis \_Tilt \_Angle = arcsin \frac{{}_{ }^{s}{A}{}_{mx}^{ }}{{}_{ }^{0}{A}{}_{e}^{ }}$$
Aₘ is a measured acceleration along said second axis,
Aₑ is a constant of 9.81 m/s².

15. A tilt sensor system according to claim 9, wherein said first and second movement sensors are single axis sensors.

16. A method for measuring a tilt of an object oriented at an angle α with respect to the vertical plane by sensing a minimum number of degrees of freedom, the method comprising:
a) measuring the tilt of a first movement sensor along a first axis via a measured acceleration in the direction of said first axis;
b) measuring the tilt of a second movement sensor along a second axis via a measured acceleration in the direction of said second axis; and
c) calculating said angle α from said measured tilt along said first axis and said measured tilt along said second axis.

17. A method according to claim 16, wherein said means for calculating said angle α from said measured tilt along said first axis and said measured tilt along said second axis, further comprises:
a) calculating a normal vector V to the angle α as:
V+\sqrt{^{s}Aₘₓ²+^{s}A_{my}²+9.81²}
A_{my} is a measured acceleration in the y-axis,
Aₘₓ is a measured acceleration in the x-axis, and
Aₑ is a constant of 9.81 m/s²
b) computing the angle α from the normal vector V.

18. A method according to claim 17, wherein the angle α is computed from the normal vector V as:
$$\frac{V}{\vert V \vert} \cdot ( \begin{matrix}0 \\ 0 \\ 1\end{matrix} ) = cos α .$$

19. A method according to claim 17, wherein the angle α is computed from the normal vector V as:
$$arccos \sqrt{1 - {( \frac{{}_{ }^{s}{A}{}_{mx}^{ }}{{}_{ }^{0}{A}{}_{e}^{ }} )}^{2} - {( \frac{{}_{ }^{s}{A}{}_{my}^{ }}{{}_{ }^{0}{A}{}_{e}^{ }} )}^{2}} = α .$$

20. A method according to claim 17, wherein the angle α is computed from the normal vector V as:
$$arcsin \sqrt{{( \frac{{}_{ }^{s}{A}{}_{mx}^{ }}{{}_{ }^{0}{A}{}_{e}^{ }} )}^{2} + {( \frac{{}_{ }^{s}{A}{}_{my}^{ }}{{}_{ }^{0}{A}{}_{e}^{ }} )}^{2}} = α .$$

21. A method according to claim 16, wherein said means for calculating said angle α from said measured tilt along said first axis and said measured tilt along said second axis, further comprises:
measuring the tilt of a movement sensor along an axis perpendicular to the horizontal plane; and
calculating said angle α as:
$$α = arccos \frac{{}_{ }^{s}{A}{}_{mz}^{ }}{{}_{ }^{0}{A}{}_{e}^{ }} .$$
